(19) United States
(12) Patent Application Publication
(10) Pub. No.: US 2003/0031469 A1
(43) Pub. Date: Feb. 13, 2003

(54) VIDEO RECORDING DEVICE HAVING PORTRAIT PHOTOGRAPHING MODE

(76) Inventor: JUN HIRAI, TOKYO (JP)

Correspondence Address: FROMMER LAWRENCE & HAUG, 745 FIFTH AVENUE- 10TH FL., NEW YORK, NY, 10151, US

(21) Appl. No.: 09/197,331

(22) Filed: Nov. 20, 1998

(30) Foreign Application Priority Data
Dec. 1, 1997 (JP) 09-330449

(51) Int. Cl. H04N 5/76; H04N 5/225

(52) U.S. Cl. 386/120; 348/220.1

(57) ABSTRACT

A video recording/playback device comprising a video recording means having, at least, a first moving picture mode, a second moving picture mode and a first still picture mode and the device being able to record a video signal in selecting a mode among the above-mentioned 3 modes. The second moving picture mode is called a portrait mode and in this mode, in comparison with the first moving picture mode, the number of frames per second is made smaller and the number of bits allotted to a frame is made larger; thereby enough number of bits can be allotted to an frame, which makes it possible to obtain a high quality portrait with desirable expression.

### BACKGROUND OF THE INVENTION

The present invention relates to a video recording/playback device and in particular it relates to a video recording/playback device with which a high quality still picture can be obtained when the device is especially used for photographing portraits.

There have been some methods to obtain still pictures such as a method to obtain a still picture by taking a photograph with an optical camera using a silver salt film, a method to obtain a still picture by displaying an image obtained with an electronic still camera using an electric image pickup element such as a CCD (Charge Coupled Device) or a method to obtain a still picture by displaying an image obtained with a video camera in a mode called a photo-mode on a monitor or by printing out the image with a printer.

In recent years, it goes on increasing to obtain still pictures by an electrical means because of the immediateness to obtain them or the affinity with personal computers. The research and development of upgrading the quality of pictures is also moved forward.

For example, in the DV format (a digital recording VTR format using a 6 mm tape), in which moving pictures or still pictures are successively recorded on recording media such as tapes or discs, an intraframe (coding in a frame) recording system, in which the data compression of DCT (Discrete Cosine Transform) base is used, is adopted, so that when pictures are photographed in a moving picture mode, in the playback operation the deterioration in the picture quality caused by the compression of data cannot be avoided in every frame.

In a case where compression rate is increased with interframe (between frames in the forward direction) compression as in the MPEG(Moving Picture Experts Group)-11, picture quality differs in every frame in a GOP (Group Of Pictures), therefore even if it can be allowed in the playback as a moving picture, when a frame is picked up, in many cases, block distortion or mosquito-noise becomes conspicuous.

In the still picture mode, enough number of bits are assigned to be able to maintain high picture quality as a still picture. In the case of photographing a scenery, there will be enough period of time to examine field angles, etc., so that a still picture of high quality will be obtained by using the still picture mode. However, there has been a problem in photographing a portrait. A man's expression is always changing, so that if the still picture mode is selected to obtain a picture of good expression, there is a fear to loose a shooting chance. On the other hand, when a still picture is planned to obtain from a moving picture, good picture quality cannot be obtained as mentioned in the above.

### SUMMARY OF THE INVENTION

The purpose of the present invention is to offer a video recording/playback device being able to take moving pictures and still pictures and also being able to obtain easily high quality still pictures especially in photographing portraits.

The present invention was invented in consideration of the above-mentioned subject. A video recording device according to the present invention as designated in claim 1 comprises a video recording means having, at least, a first moving picture mode, a second moving picture mode and a first still picture mode, and it is able to record a video image on a recording medium in selecting one mode out of the above-mentioned 3 modes.

A video playback device according to the present invention as designated in claim 10, comprises a video playback means having, at least, a first moving picture mode, a second moving picture mode and a first still picture mode and performs playback of a video image recorded on a recording medium in correspondence to one mode among the above-mentioned 3 modes.

A video recording/playback device according to the present invention as designated in claim 18, comprises a video recording means having, at least, a first moving picture mode, a second moving picture mode and a first still picture mode, and records a video image on a recording medium in selecting one mode among the above-mentioned 3 modes, and also comprises a video playback means having a first moving picture mode, a second moving picture mode and a first still picture mode and performs the playback of a video image recorded on a recording medium in correspondence to one mode out of the above-mentioned 3 modes.

According to the present invention as designated in claim 2, claim 11 and claim 19, the first moving picture mode provided in the above-mentioned video recording device, video playback device or video recording/playback device is a mode in which image data are compressed using a technique of movement prediction.

According to the invention as designated in claim 3, claim 12 and claim 20, the second moving picture mode being provided in the above-mentioned video recording device, video playback device or video recording/playback device has a mode constitution in which a video image can be recorded at a higher quality level in comparison with the first moving picture mode in which image data are compressed using a technique of movement prediction.

According to the present invention as designated in claim 4, claim 13 and claim 21, the average transfer rate of the first moving picture mode and that of the second moving picture mode of the video recording device, video playback device or video recording/playback device are constituted to be approximately equal.

According to the present invention as designated in claim 14 and claim 22, the above-mentioned video playback device or video recording/playback device is provided with a means being able to perform the playback of only a desired image among the images photographed in the second moving picture mode and skip over other images than the desired one.

According to the present invention as designated in claim 15 and claim 23, the above-mentioned video playback device or video recording/playback device is provided with a means which makes only a desired image among the images photographed in the second moving picture mode a representative image in the period of time of retrieval.

According to the present invention as designated in claim 16 and claim 24, the above-mentioned video playback device or video recording/playback device is provided with a means which is able to assign beforehand only a desired image among the images photographed in the second moving picture mode and also a means which is able to change the assigned image.

According to the present invention as designated in claim 17 and claim 25, the above-mentioned video playback device or video recording/playback device is provided with a means which is able to make only a desired image a representative image among the images photographed in the second moving picture mode in the period of time of retrieval, a means which is able to assign beforehand a desired image and a means which is able to change the assigned image.

According to the present invention as designated in claim 5 and claim 26, the above-mentioned video recording device or video recording/playback device is provided with a means which is able to record the images obtained in the second moving picture mode for a predetermined period of time every time when a recording switch is operated in the second moving picture mode.

According to the present invention as designated in claim 6 and claim 27, in the above-mentioned video recording device or video recording/playback device, a recording switch in the second moving picture mode also serves as a recording switch in the first still picture mode.

According to the present invention as designated in claim 7 and claim 28, the above-mentioned video recording device or video recording/playback device has a constitution in which the read out of a photographed image from a photographing means in the first moving picture mode, the second moving picture mode or the first still picture mode is performed by interlacing method.

According to the present invention as designated in claim 8 and claim 29, the above-mentioned video recording device or video recording/playback device is provided with a means which is able to record 2 frames in succession for the purpose of decreasing erroneous operations in the correcting operation of blurring of an interlaced signal in the second moving picture mode.

According to the present invention as designated in claim 9 and claim 30, the above-mentioned video recording device or video recording/playback device is provided with a means which records images after the previous execution of a correcting operation of blurring in an interlaced signal in the second moving picture mode for the purpose of solving the above-mentioned subject.

According to the present invention, it is made possible to obtain high quality still pictures easily, especially, in photographing portraits and even when the present invention is applied to a system in which the compression of data including the direction of the time axis, such as MPEG, is used for the recording of moving pictures, high quality still pictures can be obtained.

### BRIEF DESCRIPTION OF THE DRAWINGS

FIG. 1 shows a block diagram for the recording of a video recording/playback device according to the present invention.

FIG. 2 shows a block diagram for the playback of a video recording/playback device according to the present invention.

### DESCRIPTION OF THE PREFERRED EMBODIMENTS

According to the present invention, a moving picture mode (a second moving picture mode) is newly added for the purpose of obtaining high quality still pictures to a moving picture mode (a first moving picture mode) and a still picture mode (a first still picture mode) which have been provided to a video recording/playback device which is able to photograph moving pictures and still pictures and record them like, for example, a VTR, which makes it possible to obtain easily high quality still pictures, especially in photographing portraits.

Next, the embodiments of a video recording/playback device according to the present invention will be explained in detail. The application of the technical idea of the present invention is not limited to video recording/playback devices but naturally it can be also applied to video recording devices and video playback devices respectively with the same effect as obtained in the above.

A second moving picture mode called a portrait mode is provided in a video recording/playback device. In this mode, the number of frames per second to catch the change of expressions of a man is assumed to be 5 fps (frames per second). When a moving picture is recorded, the bit rate is decided to be, for example, 6 Mbps and the maximum transfer speed to a recording medium is also decided to 6 Mbps. In other words, the system of the device is so constituted that, in the case of the second moving picture mode, the number of frames per second is made smaller and the number of bits per frame is made larger, in comparison with the case of the first moving picture mode.

According to the conditions in the second moving picture mode, the number of bits per frame is 6 Mbits and the number of frames per second is 5; therefore, 1.2 Mbits per frame, that is, 150 kBytes can be allotted to a frame, which means that a still picture of which quality is high enough, can be obtained. It is also possible to increase the number of frames or decrease the average transfer rate using B pictures (Bidirectional predictive encoded image) or P pictures (Predictive encoded image: interframe forward directional predictive encoded image), other than the method in which all frames are made intraframes.

It can be considered that a moving picture is recorded, for example, for 3 seconds at 5 fps and the most desirable image as a still picture is selected out of these 15 frames obtained. As a method of selection, it is also possible to assign a frame beforehand and prepare a means to change the selected frame. Another method is also possible, in which all 15 frames are temporarily stored in a memory, and a user will select a frame and make it be recorded in a recording medium such as a disc. In this case a memory of more than 2.25 MBytes is needed.

Progressive scanning is better suited for photographing a still picture of a subject which moves vehemently from the point of view of blurring. However, it is difficult to photograph a moving picture with progressive scanning of 60 frames/sec; therefore, at present it is general to photograph a still picture with progressive scanning, and a moving picture with interlaced scanning. There is an established means which consists of a circuit to remove blurring from an image photographed with interlaced scanning; the technique is also applied to the present invention.

For example, images of two fields are compared with each other and a moved part is specified by pattern recognition, and the part is set with the signal of one field and for the unmoved part the signals of both fields are used. Further, there is another method in which the images of 4 fields are compared with each other. The probability of misjudgment to take vertical high resolution components for a moved part can be decreased by the method. In the method, the images of 2 fields having no blurring will be produced from the images of 4 fields and recorded. When it is considered to be better from the point of view of a memory or a circuit, 4 fields (2 frames) will be recorded 8 times in 3 seconds, and the most desirable image will be selected out of the still pictures of 16 frames.

As mentioned in the above, images in the first moving picture mode, the second moving picture mode and the first still picture mode are produced from the signal photographed by interlaced scanning and they will be recorded on a recording medium.

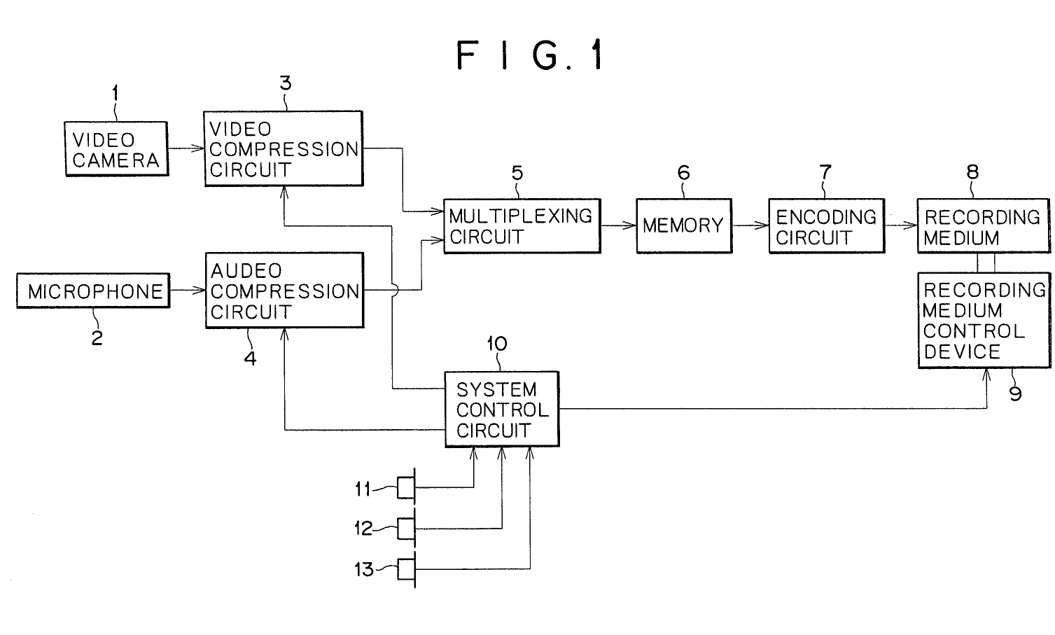

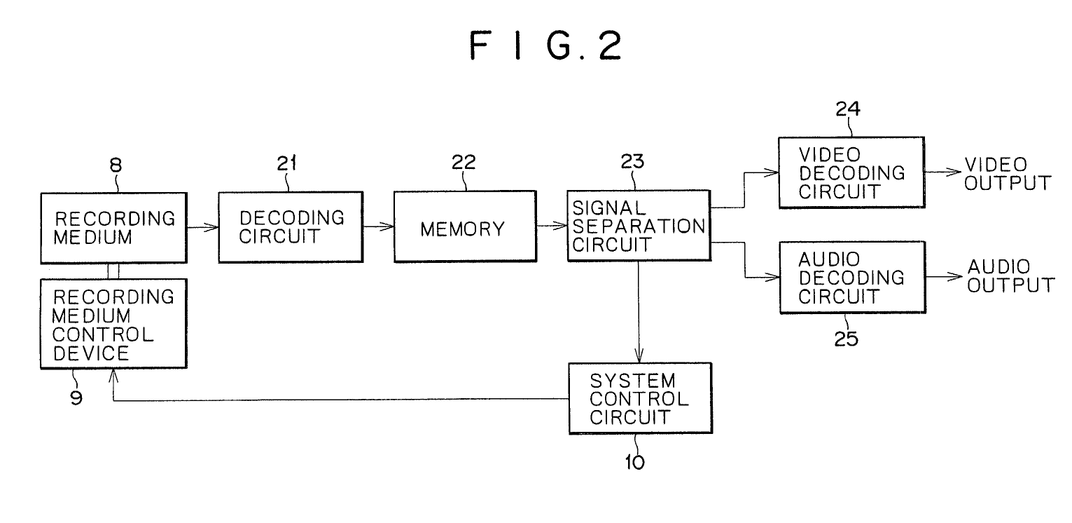

Next, the embodiments according to the present invention will be explained referring to FIG. 1 and FIG. 2. FIG. 1 shows a block diagram for the recording in a video recording/playback device according to the present invention, and FIG. 2 shows a block diagram for the playback in the above-mentioned device.

At first, in the recording time, as shown in FIG. 1, for example, a subject is photographed with a video camera 1 and simultaneously voices are taken in with an attached microphone 2. The video signal photographed with the video camera 1 is digitized and compressed in a video compression circuit 3 and simultaneously the audio signal is also digitized and compressed in an audio compression circuit 4, and they are both input to a multiplexing circuit 5, and the video signal and audio signal are multiplexed in the multiplexing circuit 5.

When a recording switch 11 is operated, its instruction is given to the video compression circuit 3 through a system control circuit 10. In this case, when the instruction is the moving picture compression according to, for example, MPEG-11, the images are compressed in the manner set in the format of MPEG-11 in the video compression circuit 3. After that, when a shutter 12 is operated, a still picture of an intraframe at the moment being compressed by the MPEG-11 format is held in the video compression circuit 3.

When the shutter 12 is operated in a state where a portrait mode switch 13 is operated, still pictures of intraframes in which number of frames is lowered to 5 fps, are compressed for a predetermined period of time, for example, for 3 seconds. At this time, the status of the portrait mode switch is recorded on a sub-code. The circuit can be so arranged that when the portrait mode switch 13 is again operated the status will be back to the former state.

The transfer rate of the signal multiplexed in the multiplexing circuit 5 is leveled in a memory 6. The signal added with codes as an error correction code, etc. in the encoding circuit 7 is modulated to a signal for recording and recorded on a recording medium 8. The recording of a signal on the recording medium 8 is executed by a recording medium control device 9 having a recording/playback head, etc. being controlled by a control signal from the system control circuit 10.

An arrangement shown in the following is also serviceable:

when a satisfactory still picture is not obtained in 3 seconds, the still pictures in the following 3 seconds can be recorded in operating the shutter 12 again.

In the playback time, as shown in FIG. 2, the images recorded on the recording medium 8 are played back when the recording medium control device 9 is controlled to do so by a control signal from the system control circuit 10. The signal played back is sent to a decoder circuit 21 and decoding, error correction, etc. are performed there. After that the signal is converted to a continuous bit stream in a memory 22 and it is divided into a video signal, an audio signal, a sub-code, etc. in a signal separation circuit 23. The separated video signal is demodulated in a video decoding circuit 24 and output as a video signal. The separated audio signal is demodulated in an audio decoding circuit 25 and output as an audio signal.

In a case where a portrait mode is detected in the separated sub-code, various methods can be considered as shown below:

a method in which the signal of 5 fps is played back as it is, a method in which a still picture at a predetermined position is output automatically, a method in which a still picture to be played back is selected by an external operation and it is displayed, and so on.

In particular, when a still picture is a portrait, it is also possible to arrange as shown in the following:

a frame of a good expression of a man will be selected and marked, and it will be described in the sub-code, and after that in a case where the playback of it is needed, the marked frame can be played back for a predetermined period of time.

What is claimed is:

1. A video recording device comprising a video recording means having, at least, a first moving picture mode, a second moving picture mode and a first still picture mode, said device being able to record a video signal on a recording medium in selecting a mode out of said 3 modes.

2. A video recording device as designated in claim 1, wherein said first moving picture mode is a mode in which an image is compressed using a technique of movement prediction.

3. A video recording device as designated in claim 1, wherein said first moving picture mode is a mode in which an image is compressed using a technique of movement prediction, and also said second moving picture mode is a mode in which an image is recorded at a higher quality in comparison with said first moving picture mode.

4. A video recording device as designated in claim 1, wherein the average transfer rate of said first moving picture mode and that of said second moving picture mode are made approximately equal.

5. A video recording device as designated in claim 1, wherein in said second moving picture mode, an image obtained in said second moving picture mode is recorded for a predetermined period of time every time when a recording switch is operated.

6. A video recording device as designated in claim 1, wherein a recording switch used in said second moving picture mode serves also as a recording switch in said first still picture mode.

7. A video recording device as designated in claim 1, wherein the read of a photographed image from a photographing means in said first moving picture mode, said second moving picture mode and said first still picture mode is performed by interlaced scanning.

8. A video recording device as designated in claim 1, wherein said device comprises a means of recording 2 frames in succession in said second moving picture mode, which decreases the erroneous operations in the blurring correction of an interlaced signal.

9. A video recording device as designated in claim 1, wherein in said second moving picture mode, an image is recorded after blurring correction of an interlaced signal is performed beforehand.

10. A video playback device comprising a video playback means having, at least, a first moving picture mode, a second moving picture mode and a first still picture mode, said device being able to perform the playback of an image corresponding to a mode among said 3 modes recorded on a recording medium.

11. A video playback device as designated in claim 10, wherein said first moving picture mode is a mode in which an image is compressed using a technique of movement prediction.

12. A video playback device as designated in claim 10, wherein said first moving picture mode is a mode in which an image is compressed using a technique of movement prediction, and said second moving picture mode is a mode in which an image is recorded at a higher quality in comparison with an image recorded in said first moving picture mode.

13. A video playback device as designated in claim 10, wherein the average transfer rate in said first moving picture mode and that in said second moving picture mode are made approximately equal.

14. A video playback device as designated in claim 10, wherein said device comprises a means to play back only a desirable image among the images photographed in said second moving picture mode and skip over other images.

15. A video playback device as designated in claim 10, wherein said device comprises a means to make only a desirable image among the images photographed in said second moving picture mode a representative image during the period of retrieval.

16. A video playback device as designated in claim 10, wherein said device comprises a means to play back only a desirable image among the images photographed in said second moving picture mode and skip over other images, a means to be able to assign the desirable image beforehand, and a means to change the assigned image.

17. A video playback device as designated in claim 10, wherein said device comprises a means to make only a desirable image among the images photographed in said second moving picture mode a representative image during the period of time of retrieval, a means to be able to assign the desirable image beforehand, and a means to change the assigned image.

18. A video recording/playback device comprising:
a video recording means having, at least, a first moving picture mode, a second moving picture mode and a first still picture mode for recording an image on a recording medium in selecting a mode out of said 3 modes; and
a video playback means having a first moving picture mode, a second moving picture mode and a first still picture mode for playing back an image corresponding to a mode among said 3 modes recorded on a recording medium.

19. A video recording/playback device as designated in claim 18, wherein said first moving picture mode is a mode in which an image is compressed using a technique of movement prediction.

20. A video recording/playback device as designated in claim 18, wherein said first moving picture mode is a mode in which an image is compressed using a technique of movement prediction and said second moving picture mode is a mode in which an image is recorded at a higher picture quality in comparison with an image recorded in said first moving picture mode.

21. A video recording/playback device as designated in claim 18, wherein the average data transfer rate in said first moving picture mode and that in said second moving picture mode are made approximately equal.

22. A video recording/playback device as designated in claim 18, wherein said device comprises a means to play back only a desired image among the images photographed in said second moving picture mode and skip over other images.

23. A video recording/playback device as designated in claim 18, wherein said device comprises a means to make only a desired image a representative image during the period of time of retrieval.

24. A video recording/playback device as designated in claim 18, wherein said device comprises a means to play back only a desired image among the images photographed in said second moving picture mode and skip over other images, a means to assign said desired image beforehand, and a means to change the assigned image.

25. A video recording/playback device as designated in claim 18, wherein said device comprises a means to make only a desired image among the images photographed in said second moving picture mode a representative image during the period of time of retrieval, a means to assign said desired image beforehand, and a means to change said assigned image.

26. A video recording/playback device as designated in claim 18, wherein an image obtained in said second moving picture mode is recorded for a predetermined period of time every time when a recording switch is operated in said second moving picture mode.

27. A video recording/playback device as designated in claim 18, wherein the recording switch to be used in said second moving picture mode also serves as the recording switch to be used in said first still picture mode.

28. A video recording/playback device as designated in claim 18, wherein the read of a photographed image in said first moving picture mode, said second moving picture mode and said first still picture mode from a photographing means is performed by interlaced scanning.

29. A video recording/playback device as designated in claim 18, wherein said device comprises a means to record 2 frames in succession which decreases erroneous operations in the blurring correcting operation of an interlaced signal.

30. A video recording/playback device as designated in claim 18, wherein in said second moving picture mode, an image will be recorded after blurring correcting operation of an interlaced signal is performed beforehand.
